(19) United States
(12) Patent Application Publication
(10) Pub. No.: US 2017/0030688 A1
(43) Pub. Date: Feb. 2, 2017

(54) ONE-SIDED FILM FOR HIGH PERFORMANCE SOFT BALLISTIC APPLICATIONS

(71) Applicant: Shekoufeh Shahkarami, Ancaster (CA)

(72) Inventor: Shekoufeh Shahkarami, Ancaster (CA)

(21) Appl. No.: 15/223,072

(22) Filed: Jul. 29, 2016

Related U.S. Application Data
(60) Provisional application No. 62/199,428, filed on Jul. 31, 2015.

(51) Int. Cl. F41H 5/04; B32B 27/08

(52) U.S. Cl. CPC F41H 5/0485; B32B 27/08; B32B 2255/10; B32B 2262/02; B32B 2307/73; B32B 2307/728; B32B 2307/714; B32B 2307/558; B32B 2571/02; B32B 2255/26

(57) ABSTRACT

A ballistic article includes a fiber structure that has a plurality of fibers disposed in a polymer matrix, a film disposed on the fiber structure, and a coating disposed on the film.

### REFERENCE TO RELATED APPLICATIONS

This application claims priority to U.S. Provisional Application No. 62/199,428, filed on Jul. 31, 2015.

### FIELD OF THE DISCLOSURE

This disclosure relates to ballistic resistant articles, and in particular high performance fiber and resin laminates for protective applications.

### BACKGROUND

Materials for soft ballistic applications can include high strength fibers, such as aramid or polyethylene (PE) fibers arranged in a polymeric matrix. For instance, the fibers are arranged parallel to one another (unidirectional), although unidirectional, woven, non-woven and other fiber configurations can be used. One or more layers of ballistic material are typically stacked or laminated (bonded) to form a ballistic article.

### SUMMARY

A ballistic article according to an example of the present disclosure includes a fiber structure that has a plurality of fibers disposed in a polymer matrix, a film disposed on the fiber structure, and a coating disposed on the film.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example ballistic article including a ballistic material, a film, and a coating.

FIG. 2 illustrates another example ballistic article.

### DISCLOSURE

Materials for soft ballistic applications can include high strength fibers, including but not limited to, aramid, polyethylene (PE), ultra-high molecular weight polyethylene (UHMWPE) fibers, high molecular weight polypropylene fibers, polyamide fibers, or ultra-high molecular weight polyacrylonitrile or poly vinyl-alcohol fibers arranged in a polymeric matrix. High strength fibers have tenacity greater than 7 gpd, tensile modulus greater than 80 gpd and energy to break greater than 7 J/g. In one example, the fibers are arranged parallel to one another (unidirectional), although unidirectional, woven, non-woven and other fiber configurations can be used. One or more layers of ballistic material can be stacked or laminated (bonded) to form a ballistic article.

A thermoplastic or thermoset film can be disposed on the layer or layers of the ballistic material. The film can include but is not limited to thermoplastic polyolefins or elastomers, crosslinked thermoplastics or elastomers, polyester, polyamide, fluorocarbon, urethane, epoxy, polyvinylidiene chloride, polyvinyl chloride or some combination thereof. The films can be uniaxial or biaxial. In one example, the film is a blown thermoplastic film, such as polyethylene (PE) or ethylene-vinyl acetate (EVA) film. The film may be 0.20-0.50 mils thick. Such blown films can have poor abrasion resistance and solvent resistance. Solvents can include water or organic solvents, such as gasoline or other hydrocarbons.

A coating material can be disposed on the film to improve solvent resistance. The coating material can also be selected to provide improved hydrophobicity or oleophobicity, reduced friction and improved abrasion resistance. In one example, both the film and coating material are free of any fibers.

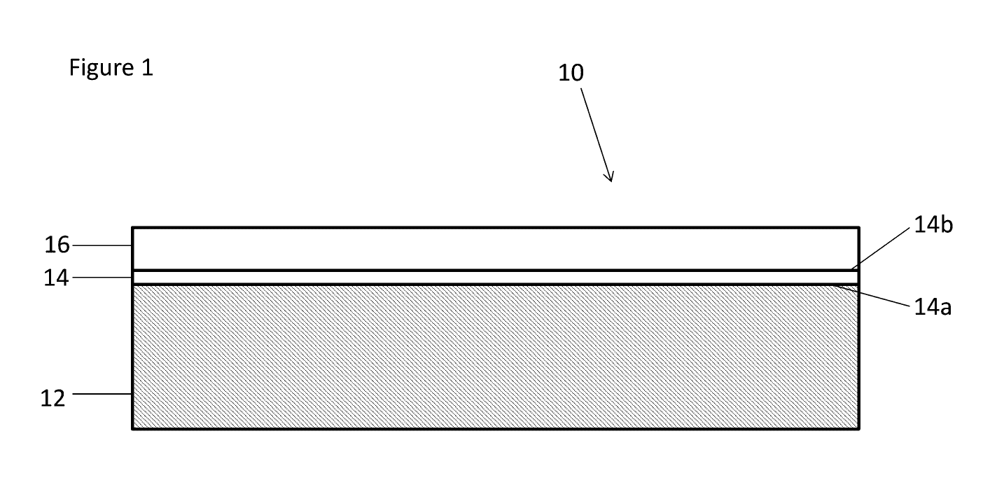

FIG. 1 shows an example ballistic article 10 including a ballistic material 12, a film 14, and a coating 16. The film 14 has an interior surface 14a facing the ballistic material 12 and an exterior surface 14b facing away from the ballistic material 12. The coating 16 is disposed on the surface 14b and is thus in direct contact with the film 14. The film 14 can be a multi-component film. In one further example, the coating 16 is thinner than the film 14. The ballistic material 12 can be a multi-layer structure, with or without fibers.

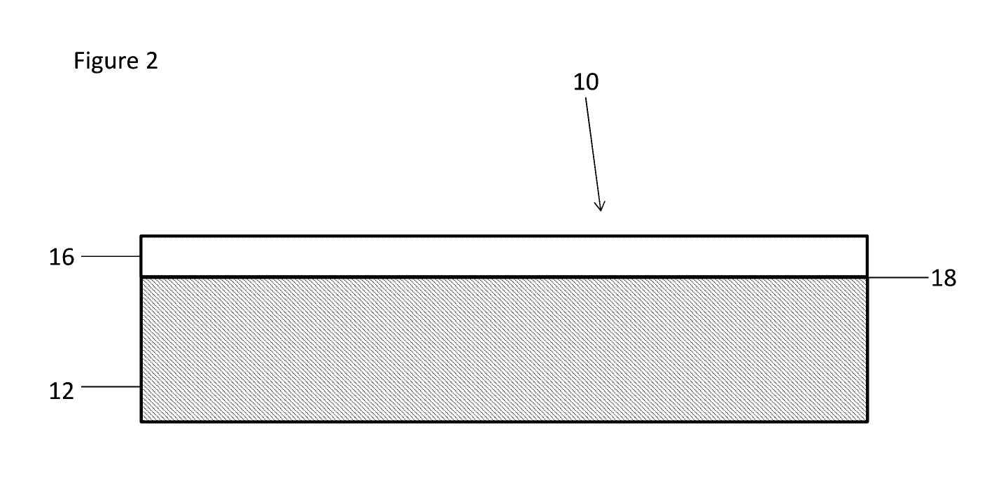

In the example of FIG. 1, the film 14 and coating 16 are applied to only one side of the ballistic material 12, and the other side is free from any additional films/coatings. However, as shown in the example in FIG. 2, the coating 16 may be disposed directly on, and in contact with, the ballistic material 12 at interface 18.

The coating 16 may be deposited on the film 14 with little or no infiltration into the film 14. In one example, the coating 16 may be deposited onto the film 14 before the film 14 is applied to the ballistic material 12. In another example, the coating 16 may be deposited onto the film 14 after the film 14 has been applied to the ballistic material 12. The coating 16 may be deposited, for instance, by a plasma treatment. However, other deposition techniques may be used.

In another example, the coating 16 has a higher hydrophobicity or oleophobicity than the film 14, the ballistic material 12, or both. Similarly, the coating 16 has a higher solvent resistance than the film 14, the ballistic material 12, or both. For example, the solvent includes water, gasoline, or other hydrocarbons. Hydrophobicity and oleophobicity can be tested by putting droplets of the water or solvent on the film and placing a cup on top to slow down evaporation. If the droplet maintains a high angle of contact, the film is hydrophobic or oleophobic for water and hydrocarbon, respectively. Solvent resistance can be tested by submerging the ballistic article in gasoline or other hydrocarbon for 4 hours before evaluating ballistic performance.

In a further example, the coating material 16 is a fluoropolymer material selected from polytetrafluoroethylene (PTFE), fluorinated ethylene propylene (FEP), perfluoroalkoxy polymer (PFA), ethylene tetrafluoroethylene (ETFE), fluoropolymer wax, or any combination thereof. Non-fluoropolymer materials with better hydrophobicity/oleophobicity, solvent resistance, or both relative to the ballistic material 12 and/or the film 14 can also be used. Further, the coating 16 can be a single or multiple-layer coating with fluoropolymer or non-fluoropolymer layers, or a combination thereof. The thickness of the single coating layer can range from 0.15 mils to 3.00 mils.

Advantages of the fluoropolymer-based material coating 16 include increased flexibility in matrix and film 14 selection for the ballistic material 12. For example, the properties of the film 14 and matrix can be more easily tailored to a specific application, and hydrophobicity or oleophobicity, abrasion resistance, and resistance to solvents can be provided by the coating 16.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A ballistic article comprising:
a fiber structure including a plurality of fibers disposed in a polymer matrix;
a film disposed on the fiber structure; and
a coating disposed on the film.

2. The article as recited in claim 1, wherein the coating has a higher hydrophobicity or oleophobicity than the film.

3. The article as recited in claim 1, wherein the coating has a higher solvent resistance than the film.

4. The article as recited in claim 1, wherein the coating has a higher resistance to hydrocarbon than the film.

5. The article as recited in claim 1, wherein the coating includes a fluoropolymer.

6. The article as recited in claim 1, wherein the coating is selected from the group consisting of polytetrafluoroethylene (PTFE), fluorinated ethylene propylene (FEP), perfluoroalkoxy polymer (PFA), ethylene tetrafluoroethylene (ETFE), fluoropolymer wax, and combinations thereof.

7. The article as recited in claim 1, wherein the coating is a non-fluoropolymer polymer.

8. The article as recited in claim 1, wherein the coating includes a fluoropolymer and a non-fluoropolymer polymer.

9. The article as recited in claim 1, wherein the coating has a thickness of 0.15 mils to 3.00 mils.

10. The article as recited in claim 1, wherein the coating is in direct contact with the film.

11. The article as recited in claim 1, wherein the fibers are unidirectional.

12. The article as recited in claim 1, wherein the fibers are non-unidorectional.

13. The article as recited in claim 1, wherein the fibers are selected from aramid fibers, polyethylene (PE) fibers, ultra-high molecular weight polyethylene (UHMWPE) fibers, high molecular weight polypropylene fibers, polyamide fibers, ultra-high molecular weight polyacrylonitrile fibers, and poly vinyl-alcohol fibers.

14. The article as recited in claim 1, wherein the film is polymeric.

15. A ballistic article comprising:
a fiber structure including a plurality of fibers disposed in a polymer matrix; and
a coating disposed on the fiber structure.

16. A ballistic article having a matrix, fibers disposed in the matrix, and a solvent resistant coating disposed on the matrix.
